(19) United States
(12) Patent Application Publication
(10) Pub. No.: US 2008/0053991 A1
(43) Pub. Date: Mar. 6, 2008

(54) MECHANICAL FASTENING FOR USE WITH A THERMAL INSULATION LINER ASSEMBLY

(76) Inventor: Stephen Kenneth Reynard, Thirsk (GB)

Correspondence Address: KIRTON AND MCCONKIE, 60 EAST SOUTH TEMPLE,, SUITE 1800, SALT LAKE CITY, UT, 84111, US

(21) Appl. No.: 11/847,542

(22) Filed: Aug. 30, 2007

(30) Foreign Application Priority Data
Aug. 31, 2006 (GB) 0617084.9

(51) Int. Cl. F16B 35/00; B65D 88/12

(52) U.S. Cl. 220/1.5; 29/428; 411/411

(57) ABSTRACT

A mechanical fastening device and method to secure a sheet liner assembly defining the walls, doors, roof and/or floor of a freight container. The anchor fastener comprises a helically formed main body having a pointed lead end configured to slice through an intermediate insulation liner of the liner assembly. A drive head is positioned at a second end of the helix to allow the device to be engaged and rotated about its longitudinal axis to drive the helical coil through the sheet liner to become embedded within the insulation liner. The drive head sits against the sheet liner which is urged against the intermediate insulation liner.

### BACKGROUND OF THE INVENTION

The present invention relates to a mechanical fastening device and method configured to secure a sheet liner to a thermal insulation liner and in particular, although not exclusively, to a freight container comprising a mechanical fastener to secure the liner assembly together.

The invention has been developed primarily, though not exclusively, in connection with the repair/refurbishment of a foamed liner assembly of the type used to provide the walls (and floor and roof) of a refrigerated freight container. However, it should be understood that the invention has wider application, to secure together the components of a thermal insulation liner assembly, both as original equipment, and also repair/refurbishment of thermal insulation liner assemblies where initially united or bonded-together components, such as a metal liner and a foamed layer, has failed over time.

A refrigerated freight container usually has a steel or aluminium frame, and walls fitted to the frame which are fabricated from foamed liner assemblies each having an outer metal lining or skin e.g. of aluminium, an inner metal lining or skin e.g. of stainless steel, and a layer of thermal insulation foam bonded to the inner and outer skins. A refrigeration unit provides chilled air to the interior of the container, and allows food e.g. meat to be readily transported while being maintained at required low temperatures.

An example of an existing foamed liner assembly forming a wall of a refrigerated freight container comprises an inner skin, an outer skin, and foam insulation located between the two skins, and bonded via its outer surfaces to the respective inner surfaces of the inner skin and the outer skin.

It is common, over an extended period of use, for the inner skin or lining to lose its bonding to the foam layer, and undergo de-lamination. This arises primarily because of the expansion and contraction which takes place of the inner (metal) skin consequent upon regular opening and closing of the access doors to the interior of the freight container. When the doors are opened to load or unload, the temperature change can be as much as 60° in a few minutes, causing rapid expansion of the inner lining and over time failure of the bond between the inner surface of the inner lining and the foam layer. Upon closing of the doors, the interior of the freight container cools down again, causing contraction of the inner lining.

Present practice to repair/refurbish delaminated foamed liner assemblies of refrigerated containers is to drill a large number of relatively large diameter holes through the inner metal skin, typically about 18 mm diameter, and then to fit 18 mm diameter coarse pitched screws (usually 100s per container) through the drilled holes and then into the foamed layer. Typically, the inner skin is approximately 1 mm thick, and when the skin has delaminated from the foam, it is a difficult task, and also time consuming, to drill many holes in the skin, bearing in mind that the (delaminated) inner skin will tend to “float”, and be difficult to drill holes through and also extract the drill once the hole is formed.

### BRIEF SUMMARY OF THE INVENTION

The present invention seeks to provide an improved mechanical fastener system, and method, which is particularly suitable for use in the construction and repair/refurbishment of thermal insulation liner assemblies used on refrigerated freight containers or vehicles, in order to re-unite the foam layer to one (or both) of the skins to which the foamed layer is no longer bonded. However, it should be understood that the invention is not restricted to such use, and may be applied with other types of insulation liner assembly, both in original assembly, and also repair/refurbishment when there has been a failure of bonding between the insulation layer and an adjacent inner or outer skin over a period of use.

Reference within the specification to a freight container includes specifically a container suitable for transportation involving loading and unloading at a cargo transport vessel or vehicle. Reference to freight container also includes a motorised vehicle or vessel comprising a non-detachable container to transport cargo.

According to a first aspect of the present invention there is provided a freight container to transport cargo comprising: a thermal insulation liner extending over at least a region of the walls of the container; a sheet liner positioned to cover at least a portion of the internal facing surfaces of said insulation liner; and a plurality of helical anchor fasteners to secure said sheet liner to said insulation liner, each of said fasteners comprising: an elongate main body formed as a helix; a pointed lead end region provided at a first end of said main body and configured to slice through said foam liner; a drive head positioned at a second end of said main body to allow said device to be engaged and rotated about the longitudinal axis of the helix to drive said main body through said sheet liner and into said insulation liner.

The drive head may be formed integrally or non-integrally with the main body. In particular, the drive head may be formed as a continuation of the wound wire bent-over at an angle relative to the longitudinal axis of the helix. Preferably, the head is formed by an extension of the wire body bent over at an angle of less than 90° relative to the longitudinal axis of the helix. Alternatively, the drive head may be formed as a button or having a dome-like configuration secured to the wire main body by welding. The drive head may comprise a recessed portion, optionally formed as a hexagonal recess to receive a drive tool to provide rotation.

Preferably, the main body comprises between two and four helical turns. Each helical turn may comprise the same diameter or the main body may be formed by helical turns of increasing, decreasing and/or alternating diameters.

Preferably, the thermal insulation liner comprises a foam material and in particular polyurethane foam. The sheet liner may comprise a metal sheet including steel, stainless steel or aluminium. Preferably, the main body of the anchor fastener comprises a metal or metal alloy in particular stainless steel. Optionally, polymer based helical fasteners may be used to secure the sheet liner to the insulation liner.

According to a second aspect of the present invention there is provided a mechanical fastening method to secure a sheet liner to a thermal insulation liner, said method comprising: forming a hole in said sheet liner to provide access to said insulation liner positioned opposed to said sheet liner; providing at least one helical anchor fastener to secure said sheet liner to said insulation liner, said anchor fastener comprising an elongate main body formed as a helix, a pointed lead end region provided at a first end of said main body and a drive head provided at a second end of said main body; entering the pointed lead end of said anchor fastener through said hole and into engagement with said insulation liner; and rotating said drive head such that said anchor fastener advances through said hole and into said insulation liner so as to become embedded therein to secure said sheet liner to said insulation liner.

The method involves driving the anchor fastener into the insulation liner until the drive head abuts the sheet liner. This driving of the fastener may be done by manually rotating the drive head or using a suitable power operated device. Optionally, the drive head is covered at the sheet liner by a covering cap, in particular a plastic covering cap configured to snap-fit in position over and about the drive head.

According to a third aspect of the present invention there is provided a mechanical fastener device configured to secure a sheet liner to a thermal insulation liner, said device comprising: an elongate main body formed as a helix; a pointed lead end region provided at a first end of said main body and configured to slice through said insulation liner; a drive head positioned at a second end of said main body to allow said drive head to be engaged and rotated about the longitudinal axis of said helix so as to drive said main body through said sheet liner and into said insulation liner; wherein said drive head comprises an engaging means to contact and abut against said sheet liner when said main body is embedded within said insulation liner so as to secure said sheet liner to said insulation liner.

The present invention provides a means and method to conveniently and securely couple both an internal and external facing liner at the internal or external faces of an insulation liner which, in part, define the walls, roof, floor and/or doors of the container, and in particular a refrigeration container. The liner assembly is secured together by a plurality of helically formed wire coils, each having a pointed leading end and an opposed drive head enabling the helical coil to be driven and embedded into the insulation liner. The drive head is also configured to abut against the sheet liner so as to force it into contact with the opposed insulation liner.

In practice, when the foam layer and the lining are no longer united/bonded together, as a result of usage over a period of time, usually a substantial portion (if not all) of the facing surfaces of the foam layer and the lining become separated, and therefore to re-unite the foam layer and the lining, it is usually necessary to form a considerable number of holes in the liner, and to provide a suitable number of fastener devices which can readily be passed through even a small (preferably drilled) hole in the liner and then cut a path through the foam to become anchored therein.

Conveniently, an anchor portion is formed of helical windings of wire, and which is sufficiently resilient to allow it to be “threaded” through the drilled hole, but sufficiently strong to cut into the foam and form a rigid anchor therein.

The driving head may be of any suitable type to be engaged with, and driven by a manual or power operated device, such as a screwdriver, spanner or socket head.

A small hole only needs to be formed, preferably by drilling, typically about 8 mm, and which can be formed quickly and easily. This is important, bearing in mind the cramped conditions in which the operator is working, and also the fact that the de-lamination of the liner makes it difficult to handle sometimes, as it may “float” relative to the foam layer.

It should be understood that the mechanical fastening device and method of the invention may also be employed to unite an insulation layer to a metal lining during initial assembly, when pre-bonding has not taken place. Additionally, the mechanical fastening device and method of the invention may be applied during initial assembly of bonded-together insultation layers and linings, to provide additional fixation, and maintain the assembly united, even if some de-lamination or de-bonding occurs with time.

### BRIEF SUMMARY OF THE DRAWINGS

A preferred embodiment of mechanical fastening system according to the invention, and its novel method of use, will now be described in detail, by way of example only, with reference to the accompanying drawings in which:

FIG. 1 is a perspective view of a freight container in which the walls, roof and doors of the container are defined by a thermal insulation liner and at least one sheet liner;

FIG. 2a is a side elevation view of a mechanical fastener having a helically formed main body and drive head;

FIG. 2b is a plan view of the fastening device of FIG. 2a;

FIG. 3 is a cross sectional side elevation view of a delaminated liner assembly and mechanical fastening device during installation;

FIG. 4 is a cross sectional side elevation view of the mechanical fastening device embedded into the insulation liner;

FIG. 5 is a side elevation view of a further specific embodiment of the mechanical fastening device having an integrally formed drive head;

FIG. 6 is a cross sectional side elevation view of the fastening device of FIG. 5 embedded within an insulation liner assembly.

### DETAILED DESCRIPTION OF THE INVENTION

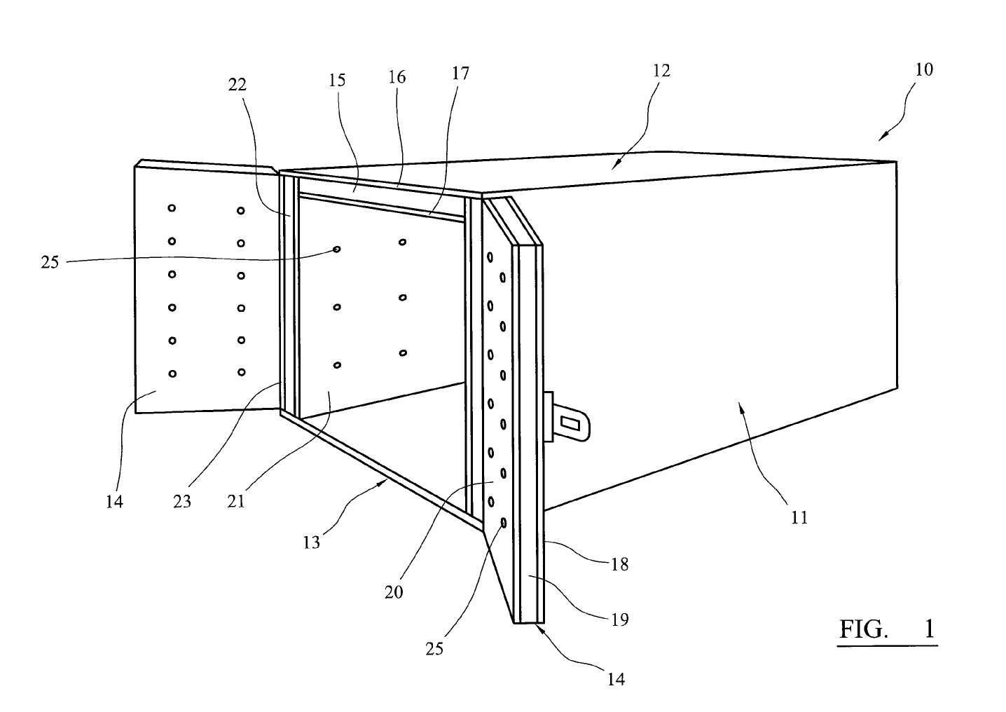

Referring to FIG. 1, a freight container 10 is defined by side walls 11, roof 10 and floor 13. A plurality of doors 14 also define one end of the container 10. The walls 11 are defined by an outer metal liner 23 and an internal sheet liner 21 with an insulation liner 22, preferably a foamed polyurethane liner 22, sandwiched between these external and internal liners 23, 21 respectively. Similarly, roof 12 is defined by inner sheet liner 17, intermediate insulation liner 15 and external sheet liner 16. Doors 14 are also defined by outer sheet liner 18 intermediate insulation liner 19 and internal facing sheet liner 20.

A plurality of helical anchor fasteners 25 secure the inner sheet liner 17, 20, 21 to the respective insulation liner 15, 19, 22.

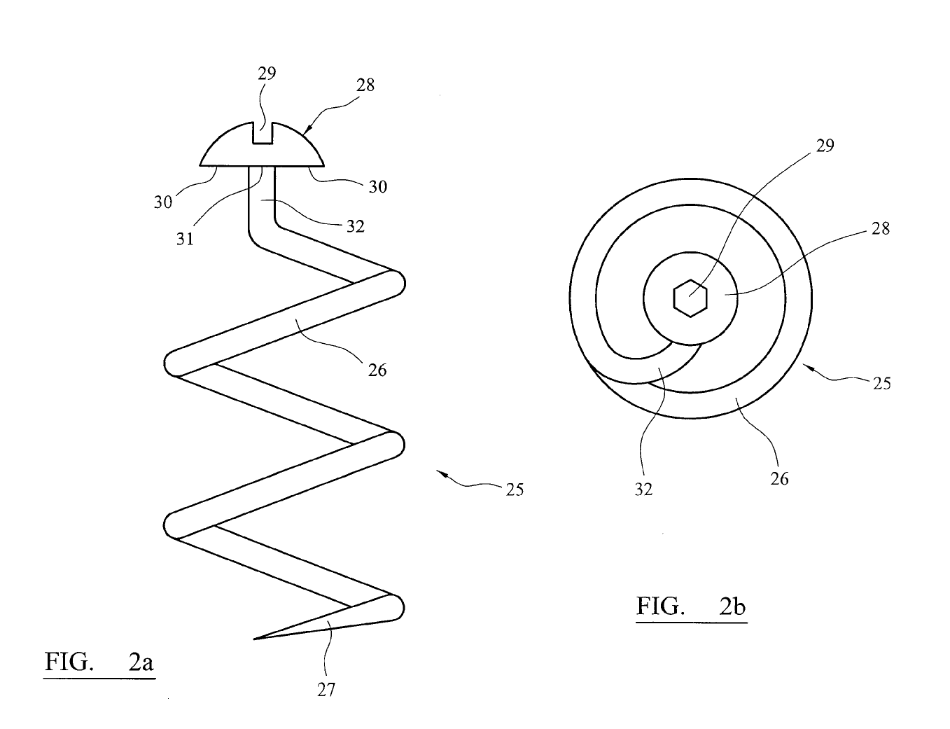

Referring to FIGS. 2a and 2b, each helical anchor fastener 25 comprises a helically wound main body 26 having a pointed lead end 27 configured to shear through the insulation liner 15, 19, 22. Each helical fastener comprises between two and four helical turns along the longitudinal axis of fastener 25. A drive head 28 is positioned at a second opposite end of the main body 26 at end region 31. The head end region of main body 26 is suitably bent to define an extension portion 32 aligned substantially parallel with the longitudinal axis of fastener 25 and positioned substantially centrally within the substantially circular coil of elongate body 26 as illustrated in FIG. 2b. Drive head 28 comprises an engaging surface 30 positioned facing the wound main body 26 and configured to sit against the substantially planar sheet liner 17, 20, 21. The dome shaped drive head 28 comprises a recessed portion 29 in the form of an indented hexagonal recess configured to receive a correspondingly shaped drive tool such as a socket head, screwdriver, spanner and the like.

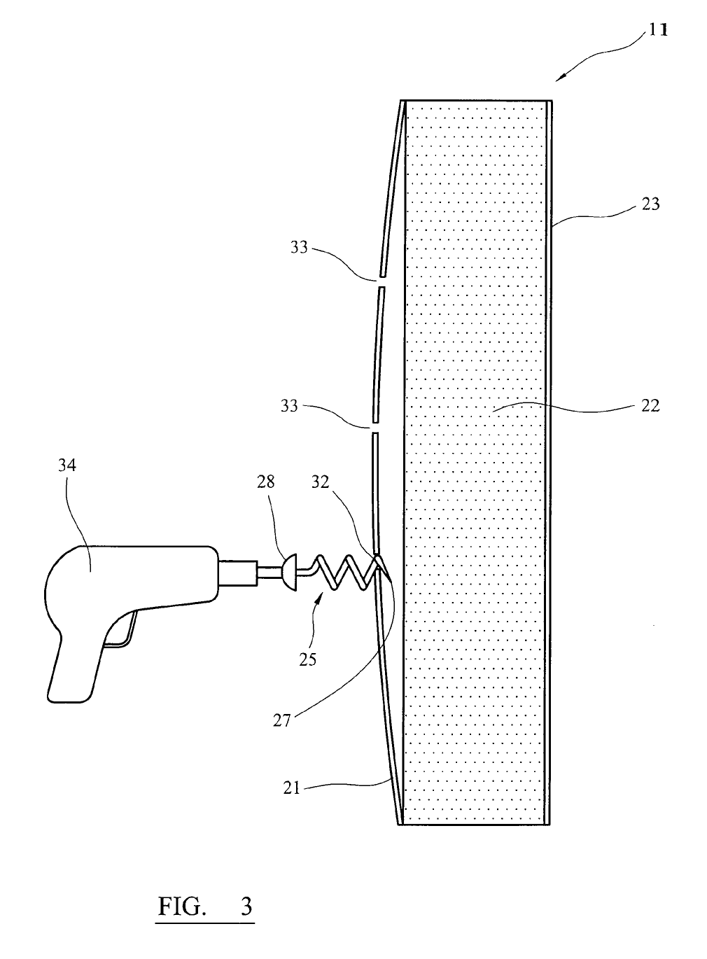

FIG. 3 illustrates wall 11 of freight container 10 in which the line assembly is delaminated. A series of holes 32, 33 are drilled through internal sheet liner 21, where each hole 32, 33 is configured to receive the wound wire body 26 of fastener 25 which is introduced through hole 32, 33 via sharpened leading end 27. In the example of FIG. 3, the drive head 28 of fastener 25 is engaged by a power drill 34 that is configured to rotate drive head 28 and fastener 25 about its longitudinal axis so as to thread fastener 25 through hole 32 and into engagement with insulation liner 22.

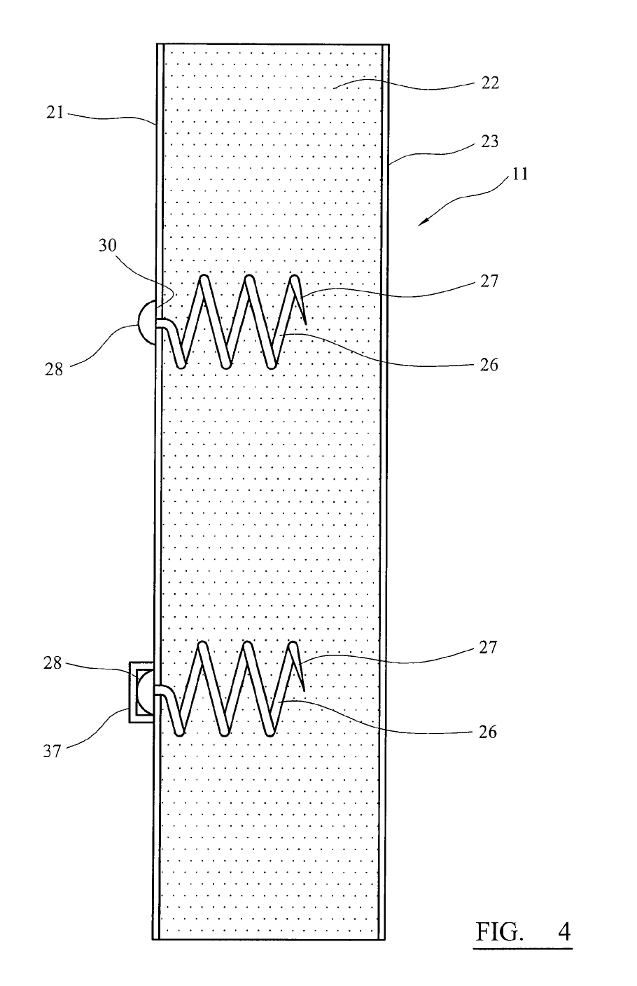

FIG. 4 illustrates a plurality of fasteners 25 embedded within foamed liner 22 of freight wall 11. Engaging surface 30 each drive head 28 is abutted against the outermost surface of sheet liner 21 so as to secure liner 21 in contact with insulation liner 22. Once the fastener 25 has been fully embedded into liner 22, the drive head 28 may be concealed by covering with cap 37 which may be ‘snap-fitted’ onto either head 28 or the hole region 32, 33 via engaging barbs (not shown) extending from cap 37.

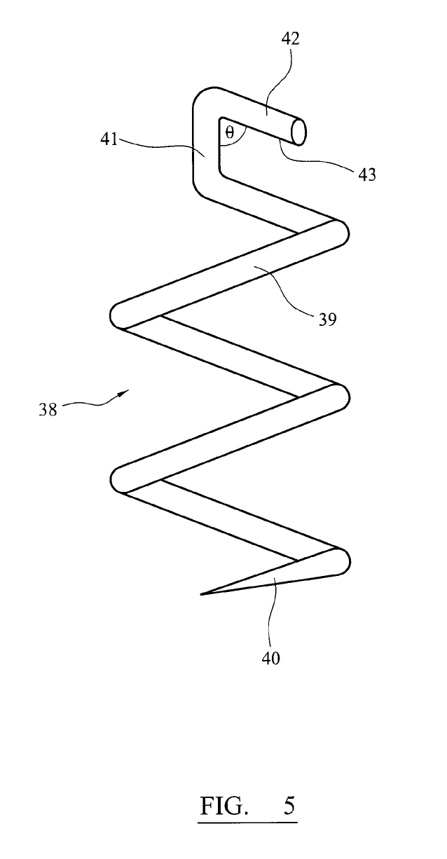

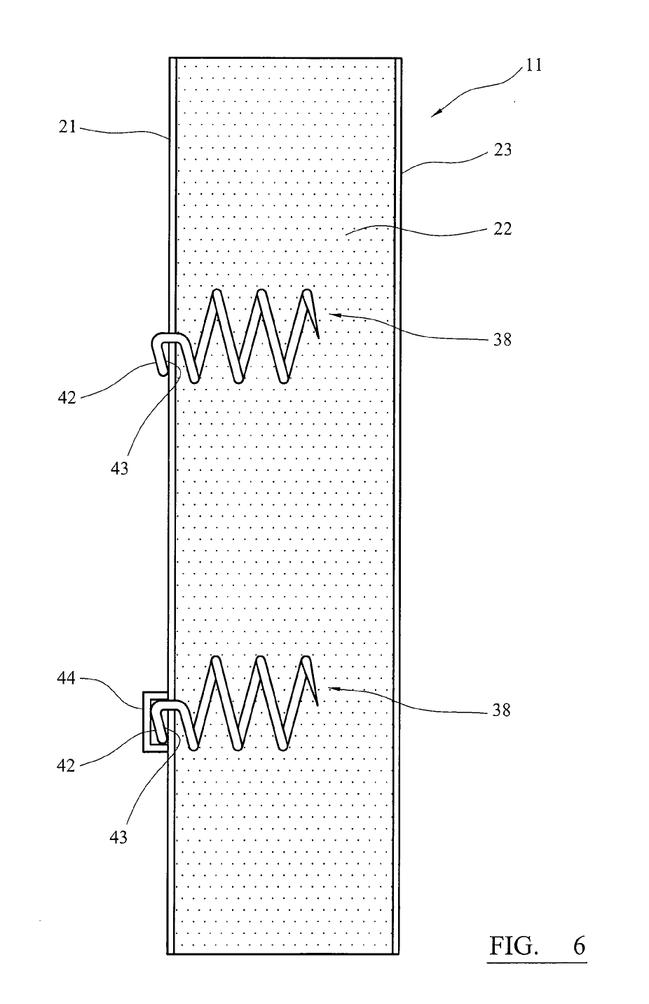

FIG. 5 illustrates a further specific embodiment of the helically wound fastening device 38 comprising a corresponding helically wound elongate main body 39. A pointed leading end 40 corresponds to lead end 27 of fastener 25. Fastener 38 comprises an integrally formed drive head 42 being an extension of the elongate metal wire body 39. Drive head 42 is linked to the coiled elongate body 39 via a substantially straight body extension 41 aligned substantially parallel with the longitudinal axis of the helix and positioned substantially centrally relative to the helical turns as per the first embodiment described with reference to FIG. 2b. Drive head 42 projects from extension 41 at an angle θ which is preferably less than 90°. In use, an underside region 43 of drive head 42 is configured to engage the external facing surface of sheet liner 21 as the main body 39 is advanced through insulation liner 22. The bend angle θ, being less than 90°, serves to increase the force with which drive head 42 compresses sheet 21 as the fastener 38 is fully embedded within the liner assembly as illustrated in FIG. 6. The drive head 42, formed by an extension of the metal wire of fastener body 39, is concealed by an end cap 44. End cap 44 may be secured in a friction locking position against drive head 42 or suitable barbs (not shown) may be provided to engage entry hole 32, 33.

Preferably, the elongate main body 26, 39 of fastener 25, 38 is made of stainless steel where the freight container 10 is configured as a refrigeration container for the transport of food. Outer lining 16, 18, 23 comprises aluminium and insulation layer 15, 19, 22 comprises a polyurethane foam optionally with additional chemical bonding materials provided at the interface of the three-part liner assembly defining the walls, roof, floor and doors of container 10.

The mechanical fastening system may be used for the construction and repair/refurbishment of a multi-layered assembly for cargo transportation containers detachable or non-detachably secured to transportation vessels and vehicles. The mechanical fastening system may be applied exclusively as a means of uniting multiple layered container assemblies or as a supplement to laminated or chemically bonded liner assemblies.

1. A freight container to transport cargo comprising:
a thermal insulation liner extending over at least a region of the walls of the container;
a sheet liner positioned to cover at least a portion of the internal facing surfaces of said insulation liner; and
a plurality of helical anchor fasteners to secure said sheet liner to said insulation liner, each of said fasteners comprising:
an elongate main body formed as a helix;
a pointed lead end region provided at a first end of said main body and configured to slice through said foam liner;
a drive head positioned at a second end of said main body to allow said
device to be engaged and rotated about the longitudinal axis of the helix to drive said main body through said sheet liner and into said insulation liner.

2. The container as claimed in claim 1 wherein each of said anchor fasteners comprises helically wound wire.

3. The container as claimed in claim 1 wherein said drive head is formed integrally with said main body.

4. The container as claimed in claim 1 wherein said drive head is formed non-integrally with said main body.

5. The container as claimed in claim 1 wherein said helix comprises at least two helical turns.

6. The container as claimed in claim 4 wherein said drive head comprises a recessed portion to receive a tool to drive rotation of said anchor fastener.

7. The container as claimed in claim 1 wherein said thermal insulation liner comprises a foam liner.

8. The container as claimed in claim 1 wherein said sheet liner comprises a metal sheet.

9. The container as claimed in claim 1 wherein said main body comprises a metal or metal alloy.

10. The container as claimed in claim 1 wherein said insulation liner and said sheet liner define the walls and roof of said container.

11. A mechanical fastening method to secure a sheet liner to a thermal insulation liner, said method comprising:
forming a hole in said sheet liner to provide access to said insulation liner positioned opposed to said sheet liner;
providing at least one helical anchor fastener to secure said sheet liner to said insulation liner, said anchor fastener comprising an elongate main body formed as a helix, a pointed lead end region provided at a first end of said main body and a drive head provided at a second end of said main body;
entering the pointed lead end of said anchor fastener through said hole and into engagement with said insulation liner; and
rotating said drive head such that said anchor fastener advances through said hole and into said insulation liner so as to become embedded therein to secure said sheet liner to said insulation liner.

12. The method as claimed in claim 11 comprising:
driving said anchor fastener into said insulation liner until said drive head abuts said sheet liner.

13. The method as claimed in claim 11 comprising:
driving said anchor fastener into said insulation liner by manually rotating said drive head.

14. The method as claimed in claim 11 comprising:
driving said anchor fastener into said insulation liner by rotating said drive head using a power operated device.

15. The method as claimed in claim 11 further comprising:
covering said drive head at said sheet liner with a covering cap.

16. The method as claimed in claim 11 wherein said insulation liner comprises a foam liner and said sheet liner comprises a metal or metal alloy sheet.

17. The method as claimed in claim 11 wherein said main body of said anchor fastener comprises a helically formed metal wire.

18. A mechanical fastener device configured to secure a sheet liner to a thermal insulation liner, said device comprising:
an elongate main body formed as a helix;
a pointed lead end region provided at a first end of said main body and configured to slice through said insulation liner;
a drive head positioned at a second end of said main body to allow said drive head to be engaged and rotated about the longitudinal axis of said helix so as to drive said main body through said sheet liner and into said insulation liner;
wherein said drive head comprises an engaging means to contact and abut against said sheet liner when said main body is embedded within said insulation liner so as to secure said sheet liner to said insulation liner.

19. The device as claimed in claim 18 wherein said drive head is formed integrally with said main body.

20. The device as claimed in claim 18 wherein said drive head is formed non-integrally with said main body.

21. The device as claimed in claim 20 wherein said drive head comprises a recessed portion to receive a tool to drive rotation of said device about said longitudinal axis of said helix.
